(19) United States
(12) Patent Application Publication
(10) Pub. No.: US 2007/0182665 A1
(43) Pub. Date: Aug. 9, 2007

(54) Display device

(75) Inventors: Yoshiyuki Tanaka, Suwa-gun (JP); Manabu Akahane, Kamlina-gun (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/652,547

(22) Filed: Jan. 12, 2007

(30) Foreign Application Priority Data
Feb. 3, 2006 (JP) 2006-026595

(51) Int. Cl. G09G 3/04

(52) U.S. Cl. 345/34

(57) ABSTRACT

A display device includes: a pattern display unit having a display area in which a background display region for displaying a background pattern that changes as time advances and an information display region for displaying a predetermined information pattern are integrally provided. A display mode of the information pattern changes in accordance with a change of the background pattern in such a manner that the information pattern is distinguishable in the display area.

The entire disclosure of Japanese Patent Application No. 2006-026595, filed Feb. 3, 2006, is expressly incorporated by reference herein.

### BACKGROUND

1. Technical Field

The present invention relates to a display device and particularly to a display control technique of a display having a display area that displays a predetermined information pattern integrally with a background pattern.

2. Related Art

There have been known various types of display devices provided with a display such as a liquid crystal display, and a variety of content is displayed in a display area of such display. The display devices typically display arbitrary images in the display areas. Among such display devices, there is known a device which simultaneously displays various types of images (background pattern) and information patterns formed from characters, graphics, symbols or the like that show predetermined information (see, for instance, JP-A-2003-209889, particularly FIGS. 8 and 11).

However, when the information pattern is displayed in the background pattern as described above, a display mode of the information pattern, e.g., the brightness, hue, shape or size is typically consistent. Consequently, when the background pattern is changed, the information pattern might be blended into the background pattern and become less visible.

It is conceivable to edge or shade the information pattern to enhance its visibility, the edged or shaded information pattern might become even less distinguishable depending on a display mode of the background pattern. In addition, the edging and shading might reduce flexibility in display design or degrade design quality of the display device.

### SUMMARY

The invention is made to solve the problems described above, and an object of the invention is to provide a display device capable of maintaining visibility of an information pattern even when a background pattern is changed.

A display device according to an aspect of the invention includes: a pattern display unit having a display area in which a background display region for displaying a background pattern that changes as time advances and an information display region for displaying a predetermined information pattern are integrally provided. A display mode of the information pattern changes in accordance with a change of the background pattern in such a manner that the information pattern is distinguishable in the display area.

According to the aspect of the invention, even when the background pattern formed in the background display region changes as time advances, the display mode of the information pattern changes in accordance with the change of the background pattern so that the information pattern is kept distinguishable in the display area. Accordingly, the visibility of the information pattern is ensured no matter how a display mode of the background pattern changes.

Examples of the change of the display mode of the information pattern include change in a display position, change in a pattern shape (including edged shape and shaded shape), change in a pattern size, change in hue, change in brightness, change between a constant display state and a blinking display state, change between fixing and changing of the pattern shape or the pattern size and the like.

In the display device according to the aspect of the invention, the display mode of the information pattern preferably changes in such a manner that the information pattern and a portion of the background pattern that is adjacent to the information pattern differ in at least one of hue and brightness. With the arrangement, by changing the display mode of the information pattern such that the information pattern and the portion adjacent to the information pattern differ in at least one of the hue and the brightness, the position, the shape or the size of the information pattern does not have to be changed, thereby securely making the information pattern visible with minimized change in a display design. In addition, since a control can be performed only by hue adjustment or gradation adjustment, display control can be easily performed.

In the display device according to the aspect of the invention, it is preferable that a plurality of pixels are arranged vertically and horizontally in the background display region, and the information display region is formed by one or more segment areas disposed in at least one pixel of the plurality of pixels. By arranging one or more segment areas in the at least one pixel out of the plurality of pixels disposed in the background display region and forming the information display region from the segment areas, the information display region can be integrally incorporated in the background display region. Accordingly, the design quality can be enhanced and the visibility of the information pattern can be ensured to a certain extent only by using a relation between the display mode of the at least one pixel and the display mode of the segment areas, which allows the display control to be easily performed.

In the display device according to the aspect of the invention, it is preferable that the one or more segment areas that form the information pattern change so as to be different from the at least one pixel at least in the hue and the brightness. With the arrangement, the position, the shape or the size of the information pattern does not have to be changed, thereby securely making the information pattern visible with minimized change in the display design. In addition, since the control can performed only by the hue adjustment of the gradation adjustment, the display control of the information pattern can be easily performed.

In the aspect of the invention, the pattern display unit may control, in some cases, the display area based on display data in which a data component related to the display mode of the information pattern corresponding to the background pattern has been reflected in advance. In such case, since the data component related to the display mode of the information pattern corresponding to the background pattern has been reflected in advance, the display control can be performed quickly and easily without necessity of performing computation.

The pattern display unit may, in other cases, obtain a data component related to the display mode of the information pattern from a display data portion of the background pattern and control the display area based on the display data in which the obtained data component is reflected. In such case, since the data component related to the display mode of the information pattern is obtained from the background pattern, image data input from the outside, for instance, can also be used.

A display device according to another aspect of the present invention includes a pattern display unit having a display area in which a background display region for displaying a background pattern that changes as time advances and an information display region for displaying a predetermined information pattern are integrally provided. The information pattern repeatedly changes between a plurality of different display modes.

According to the aspect of the invention, the information pattern repeatedly changes between different display modes. With the arrangement, even when one of the display modes of the information pattern is difficult to be distinguished from the background pattern, distinguishability can be secured by another display mode or by the change of the display modes of the information pattern, thereby keeping the information pattern distinguishable even when the background pattern changes. Here, a time interval of the repeated change of the information pattern is preferably constant and is preferably different from a time interval of the background pattern. Particularly, a cycle of the repeated change of the information pattern is preferably set such that blinking of the information pattern can be sensed, which is, for instance, approximately 0.1 to 3.0 seconds.

In the display device according to the aspect of the invention, the information pattern is preferably a pattern showing time information. With the arrangement, the time information (e.g., year, season, month, week, day, morning, afternoon, time, time period) can be securely recognized. In addition, arbitrarily setting and changing of the background pattern enables improvement in appearance, increase in design variation and achievement of fashionability of the display device.

The display device according to the aspect of the invention is be a watch, a computer, a mobile phone, a game console, a television, an audio device, a car navigation device, a remote controller, a printer and the like.

### BRIEF DESCRIPTION OF THE DRAWINGS

The invention will be described with reference to the accompanying drawings, wherein like numbers reference like elements.

FIG. 1 is a perspective view schematically showing a display device according to an exemplary embodiment of the invention;

FIG. 2 is a vertical sectional view schematically showing a cross section structure along a curved direction of the display device according to the exemplary embodiment;

FIG. 3A is a sectional view showing a cross section structure cut in a width direction of a portion Sa in FIG. 2;

FIG. 3B is a sectional view showing a cross section structure cut in the width direction of a portion Sb in FIG. 2;

FIG. 3C is a sectional view showing a cross section structure cut in the width direction of a portion Sc in FIG. 2;

FIG. 3D is a sectional view showing a cross section structure cut in the width direction of a portion Sd in FIG. 2;

FIG. 3E is a sectional view showing a cross section structure cut in the width direction of a portion Se in FIG. 2;

FIG. 4 is a plan view schematically showing a part of a base member according to the exemplary embodiment;

FIG. 5 is a plan view schematically showing an internal module according to the exemplary embodiment;

FIG. 6 is a perspective view schematically showing a portion of the display device which is exposed by removing one cover member according to the exemplary embodiment;

FIG. 7 is a block diagram schematically showing an arrangement of a display control system according to the exemplary embodiment;

FIG. 8 is a timing chart showing an example of waveforms of a common signal and a drive signal for driving a display according to the exemplary embodiment;

FIG. 9 is an illustration showing changing process of a series of display patterns (a) to (e) according to the exemplary embodiment;

FIG. 10 is an illustration showing another example of display patterns (a) to (e) applicable to the exemplary embodiment;

FIG. 11 is an enlarged sectional view of a microcapsule used in the display according to the exemplary embodiment; and

FIG. 12 is a vertical sectional view schematically showing an internal structure of the display according to the exemplary embodiment.

### DESCRIPTION OF EXEMPLARY EMBODIMENT(S)

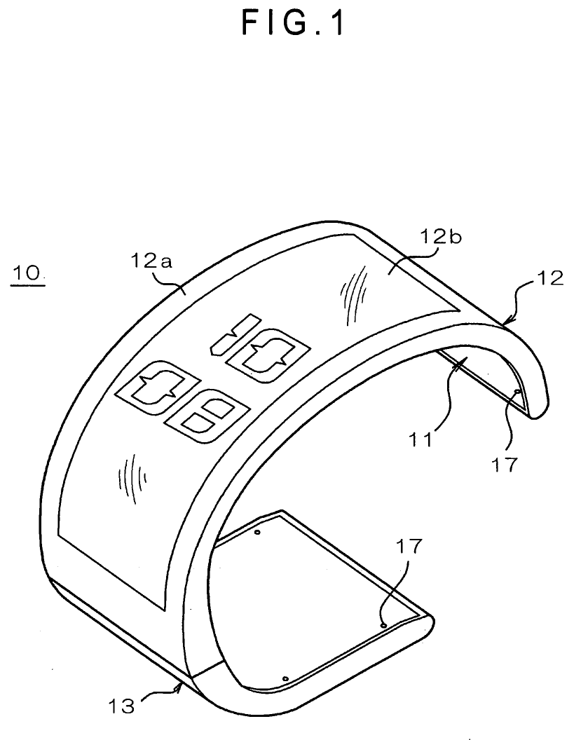

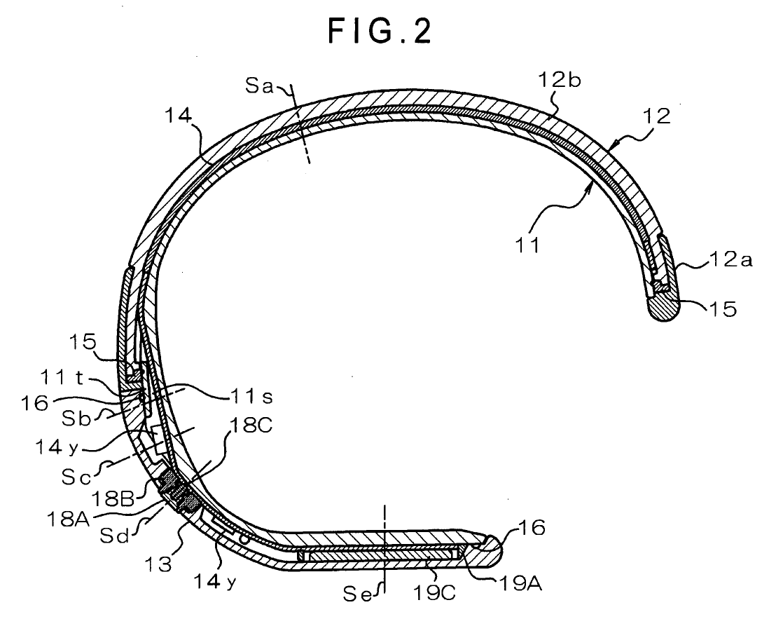

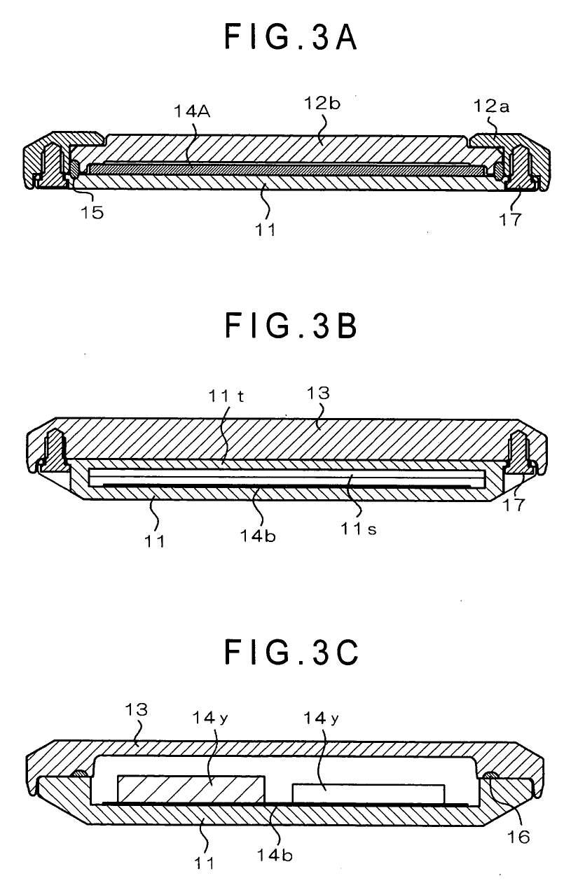

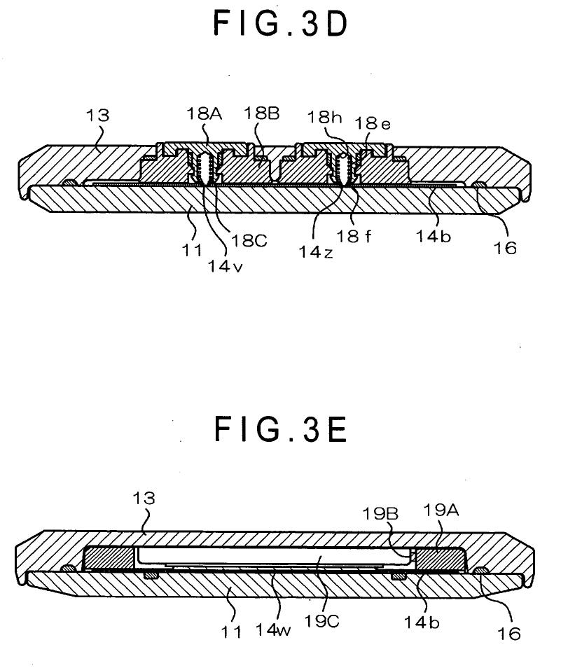

An exemplary embodiment of the invention will be described in detail with reference to the attached drawings. FIG. 1 is a perspective view schematically showing a structure of a display device according to the exemplary embodiment of the invention. FIG. 2 is a vertical sectional view showing a cross section along a curved direction of the display device. FIGS. 3A to 3E are sectional views cut in portions Sa to Se shown in FIG. 2.

A display device 10 of the exemplary embodiment is a body-worn device attached to a human body in use, which also is a mobile device, an electronic device installed with an electrical circuit therein and a watch that can show time information. More specifically, the display device 10 is a wrist-worn electronic device attached to a user's wrist in use. The wrist-worn electronic device is a wrist watch, a dive computer, a stop watch, body-sensing devices such as a blood pressure monitor or the like, each function of which will not be described in detail.

The display device 10 includes a base member 11 having a curved belt-like shape and two cover members 12, 13 attached on a front surface side of the base member 11. An internal module 14 is housed in a casing structure defined by the base member 11 and the cover members 12, 13.

The base member 11 is made of metal such as stainless steel, synthetic resin or the like and is rigid to keep its curved shape self-supportedly, namely in a state where the base member 11 does not receive any stress other than the gravity. The base member 11 is curved substantially in a C-shape. More specifically, the base member 11 has a curved shape substantially along a circumference of an arm (especially a wrist) or a curved shape substantially along an ellipse.

While the base member 11 is rigid to keep the shape self-supportedly as described above, the base member 11 is preferably elastic to some extent so that the user can somewhat deform the base member 11 by one's hand to wear or remove the display device 10. Although the base member 11 can be manufactured by pressing or forging, the base member 11 is preferably manufactured by cutting off from a block (or a plate) of materials such as metal by electrical discharge machining or the like into the above-described curved shape in order to achieve high accuracy of the curved shape.

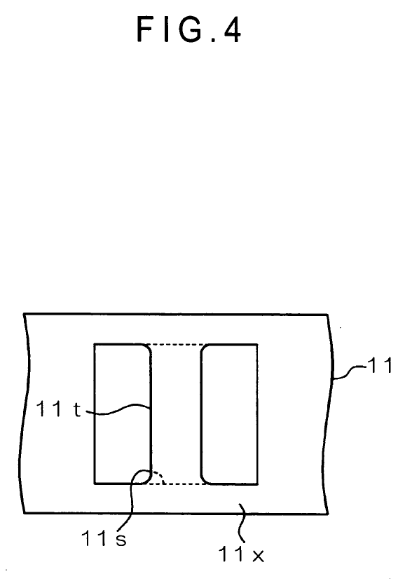

FIG. 4 is a plan view showing a part of the base member 11. A bridge portion 11t is formed on a part in a curved direction (i.e., longitudinal direction) of the base member 11, the bridge portion 11t being formed in a manner intersecting with (at right angles in the illustrated example) the curved direction of the base member 11. As shown in FIG. 3B, the bridge portion 11t has a through portion 11s on a back side thereof which extends through the bridge portion 11t in the curved direction. The bridge portion 11t is formed at the middle of the above-described curved shape. The bridge portion 11t extends in a width direction of the base member 11, both ends of the bridge portion 11t being connected to a circumferential portion 11x of the base member 11.

A front surface of the bridge portion 11t is continuous to the circumferential portion 11x of the base member 11. In the illustrated example, the front surface of the bridge portion 11t is flat in the width direction (the up-down direction in FIG. 4) and is curved substantially along the curved shape of the base member 11 in the curved direction (the right-left direction in FIG. 4). However, the front surface of the bridge portion 11t may be flat as long as the bridge portion 11t and the circumferential portion 11x of the base member 11 to which the bridge portion 11t is connected have surface profiles continuous to each other. Herein, having the continuous surface profiles means that the bridge portion 11t and the circumferential portion 11x have no bend portion with its curvature radius smaller than that sealable with generally-used packing or the like.

The cover member 12 has a curved shape corresponding to the curved shape of the base member 11, the cover member 12 attached on the front surface of the base member 11. The cover member 12 includes a frame 12a made of metal such as stainless steel, synthetic resin or the like and a display window 12b formed inside the frame 12a. The display window 12b is formed from a transparent material (glass, or transparent resin) and is fitted and fixed in the frame 12a. However, the display window 12b may be formed as an opening without any material or the entire cover member 12 may be formed from the transparent material. As shown in FIG. 3A, it is so arranged that (a display area 14x) of a display 14A of the internal module 14 (described later) is visible through the display window 12b.

Formed on a circumferential portion of a back surface of the cover member 12 are packing boxes in which packing 15 having a closed curve shape (rectangular frame shape) is provided. The base member 11 and the cover member 12 closely contact with each other via the packing 15. However, the packing 15 may be provided in a packing box formed on the base member 11 as long as the base member 11 and the cover member 12 somehow closely contact with each other via the packing 15. The base member 11 and the cover member 12 are fixed to each other by setscrews 17.

Formed on a circumferential portion of a back surface of the cover member 13 are similar packing boxes in which packing 16 having a closed curve shape (rectangular frame shape) is provided. The base member 11 and the cover member 13 closely contact with each other via the packing 16. However, the packing 16 may be provided in a packing box formed on the base member 11 as long as the base member 11 and the cover member 13 somehow closely contact with each other via the packing 16. The base member 11 and the cover member 13 are fixed to each other by setscrews 17.

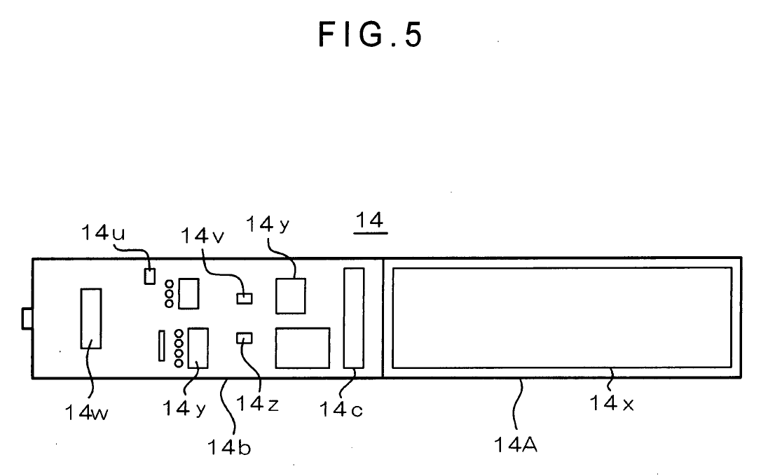

FIG. 5 is a plan view of the internal module 14. The internal module 14 has a belt-like shape in which the display 14A and a wiring board 14b are conductively connected, the entire internal module 14 having flexibility at least in the curved direction of the base member 11.

The display 14A includes the display area 14x having a belt-like shape extending in the curved direction of the base member 11. Accordingly, a display screen of the exemplary embodiment extends along the curved direction of the above-described curved casing structure. The display screen occupies a high area ratio (40% or higher, preferably 50% or higher) in the surface area of the display device 10, and therefore a display mode of a display pattern (described later) of the display screen plays a decisive role in determining design quality of the display device 10.

The wiring board 14b is a flexible board made of a polyimide resin or the like and wiring is provided on or within the board. Formed on an end of the wiring board 14b is a terminal portion 14c to which a terminal of the display 14A is conductively connected. Electronic components 14y such as IC chips and the like are mounted on a surface of the wiring board 14b. In addition, electrodes (pads) 14z, 14v for connecting switches and electrodes (pads) 14w, 14u for connecting a cell are formed on the surface of the wiring board 14b. A control/drive system of the display 14A is formed on the wiring board 14b, which will be described later.

The internal module 14 is housed between the base member 11 and the cover members 12, 13 such that the display 14A is disposed on an inner side of the cover member 12 and the wiring board 14b is disposed on an inner side of the cover member 13. As shown in FIG. 3B, the internal module 14 is so arranged that the internal module 14 passes through the through portion 11s formed on the back side of the bridge portion 11t of the base member 11 and extends to reach both sides in the curved direction of the bridge portion 11t. The wiring board 14b of the internal module 14 is preferably set so that a portion provided with the terminal potion 14c to which the display 14A is conductively connected is inserted in the through portion 11s. With the above arrangement, the display 14A is not covered with the bridge portion 11t. In addition, since a mounting area of the electronic components 14y and a formation area of the electrodes 14z, 14v for connecting the switches can be disposed out of the through portion 11s, the thickness of the through portion 11s can be reduced, thereby reducing the thickness of a portion on which the bridge portion 11t is formed (i.e., an area in which the bridge portion 11t and the through portion 11s are formed in parallel in a thickness direction).

In the illustrated example, an internal bottom surface of the bridge portion 11t that faces the through portion 11s is flat in order to facilitate its machining and to facilitate the insertion of the internal module 14. However, the internal bottom surface may be curved corresponding to the curved shape of the base member 1.

The front surface of the bridge portion 11t closely contacts with ends of the cover members 12, 13 via the packing 15, 16. As mentioned above, since the front surface of the bridge portion 11t is continuous to the circumferential portion of the base member 11, a gap is hardly generated between the packing 15, 16 and the bridge portion 11t and between the packing 15, 16 and the circumferential portion of the base member 11. Accordingly, the internal space of the casing structure defined by the base member 11 and the cover member 12 and the internal space of the casing structure defined by the base member 11 and the cover member 13 are securely sealed with the packing 15, 16, respectively.

The cover member 13 is provided with an opening 13a in which switch terminals 18A and an insulating frame 18B are attached (fixedly fitted), the switch terminals 18A conductively connected to the electrodes 14z, 14v that are formed on the wiring board 14b, the insulating frame 18B made of synthetic resin or the like and interposed as a frame between the switch terminal 18A and the cover member 13. The switch terminals 18A conductively contact with the electrodes 14z, 14v via coil springs 18C. The coil spring 18C includes a cylindrical portion 18e housed inside a housing hole 18h formed in a bottom portion of the switch terminal 18A and a truncated cone portion 18f connected to a lower portion of the cylindrical portion 18e and having a diameter gradually reduced downward, the truncated cone portion 18f being held by an opening edge of the housing hole 18h so as not to be disengaged therefrom.

The spiral coil structure of the coil spring 18C is so arranged that the cylindrical portion 18e is housed in the housing hole 18h in a compressed state so as to exhibit resilient force for securing conductive contact pressure and the truncated cone portion 18f is constantly kept in a closely wound state, a tip of the truncated cone portion 18f abutting on each electrode 14z, 14v. The truncated cone portion 18f is constantly kept in the closely wound state so as not to change its shape, thereby securing stability of the conductive contact between the truncated cone portion 18f and each electrode 14z, 14v.

When the user touches the switch terminal 18A and a portion of the cover member 13 around the switch terminal 18A by one's finger or the like, a potential of each electrode 14z, 14v conductively connected to the switch terminal 18A changes and the switching operation is detected, by which a predetermined operation, e.g., switching or setting of content to be displayed on the display is performed by a predetermined circuit formed on the wiring board 14b.

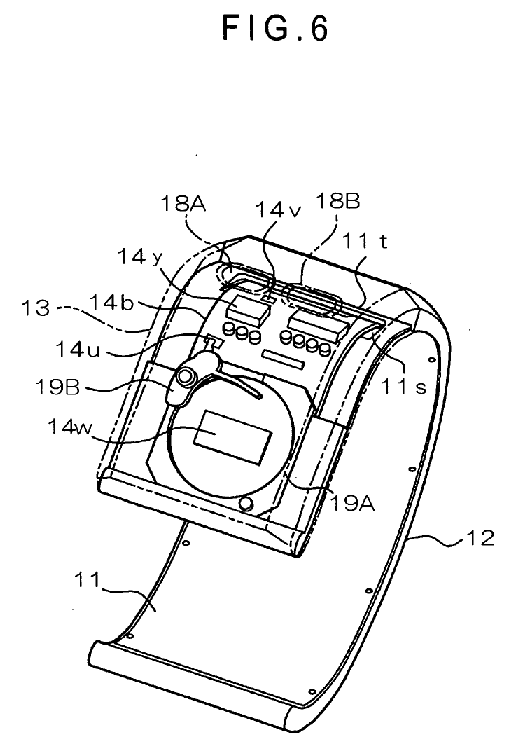

FIG. 6 is a perspective view schematically showing an exposed portion from which the cover member 13 is removed. A cell holder frame 19A and an electrode terminal 19B are fixed on the wiring board 14b. When a cell 19C shown in FIGS. 2 and 3E is housed in the cell holder frame 19A, an electrode provided on a bottom surface of the cell 19C conductively contacts with the above-described electrode 14w provided on the wiring board 14b, while an electrode provided on a lateral surface of the cell 19C conductively contacts via the electrode terminal 19B with the above-described electrode 14u provided on the wiring board 14b.

The cover member 13 has an internal profile with projections and dents corresponding to the thickness of the wiring board 14b, so that the thickness of the internal space defined by the base member 11 and the cover member 13 varies in portions. For example, the thickness of the internal space is large at a portion on which the electronic components 14y are mounted on the wiring board 14b as shown in FIG. 3C, while the thickness of the internal space is slightly larger than the thickness of the wiring board 14b at a portion on which the electronic components 14y are not mounted as shown in FIG. 3D.

In the exemplary embodiment described above, the user can wear the display device 10 on one's arm (especially a wrist) from an opening portion of the curved shape of the display device 10 that is curved substantially in C-shape. Unlike related-art wrist-worn portable devices such as a wrist watch and a dive computer, the display device 10 is formed in a belt-like (bracelet-like) shape along a wearing portion (arm), which realizes an innovative design. Further, the display device 10 can be downsized and thinned while securing the long display area in the curved direction along the wearing portion. Still further, since the internal module 14 is integrally formed, the display device 10 can be formed from a reduced number of components and can be assembled with ease. Since the entire internal module 14 is flexible in the curved direction, namely both of the display 14A and the wiring board 14b are flexible in the curved direction, the internal module 14 can be housed in the casing structure in a fitted manner.

Especially, in the exemplary embodiment, since the display screen defined by the display area 14x of the display 14A occupies the large proportion in the surface area of the display device 10, the display pattern described below gives a decisive and important influence on the design quality of the display device 10.

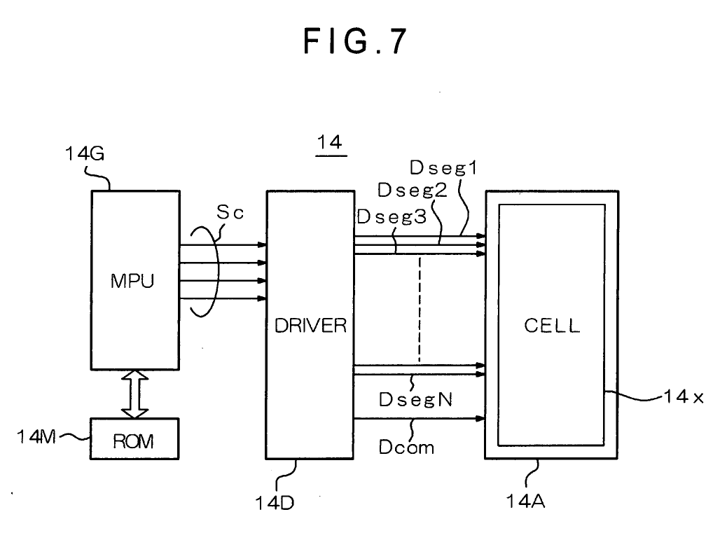

FIG. 7 is a block diagram schematically showing an arrangement of the control/drive system of the display 14A. The display 14A mounted on the display device 10 can display predetermined display content by the control/drive system shown in FIG. 7. A display controller 14G is a micro processing unit (MPU) or the like, which generates display data for the display content to be displayed on the display area 14x of the display 14A. The display controller 14G reads out control data of each display pattern or pattern variation stored in a memory 14M and outputs a control signal Sc corresponding to the display data based on the control data. The control signal Sc is, for instance, a digital signal having a predetermined number of bits for driving a driver, which is a parallel signal in the illustrated example, but may be a serial signal.

When the control signal Sc is input in a display driver 14D, the display driver 14D outputs to the display 14A drive signals Dseg1 to DsegN and a common signal Dcom that correspond to the display data. The drive signals Dseg1 to DsegN (N representing an arbitrary natural number, which is the total segment numbers in the exemplary embodiment) and the common signal Dcom are analogue signals when gradation control is performed.

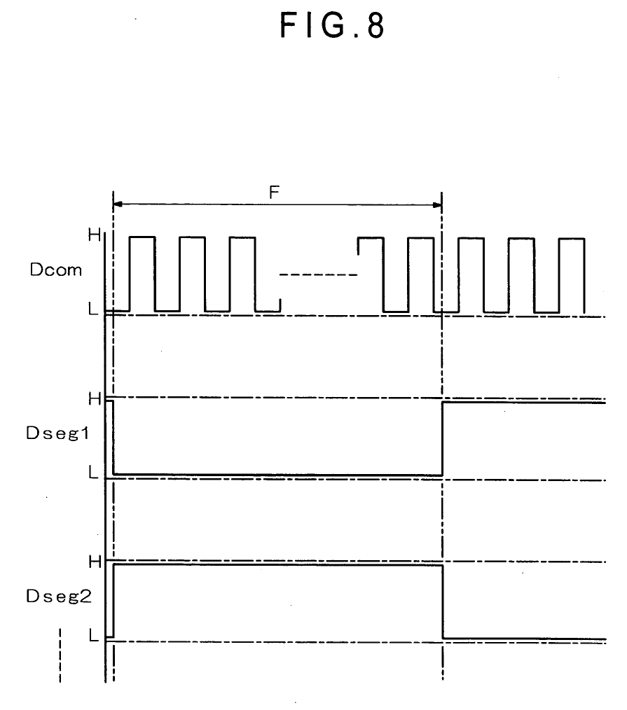

FIG. 8 shows an example of signal waveforms of the common signal and the drive signals. The common signal Dcom is a pulse signal in which a high potential (e.g., positive potential) H and a low potential (e.g., negative potential) L are alternately repeated, the high potential H and the low potential L being repeated plural number of times in one frame period F. Meanwhile, each of the drive signals Dseg1 to DsegN supplied to each segment takes either one of a high potential (e.g., positive potential) H or a low potential (e.g., negative potential) L in one frame period F. Accordingly, in a frame period where the drive signal takes the high potential H, a positive pressure relative to the common signal is applied in a pulsing (intermittent) manner to an electrode to which this drive signal is supplied. On the other hand, in a frame period where the drive signal takes the low potential L, a negative pressure relative to the common signal is applied in a pulsing (intermittent) manner.

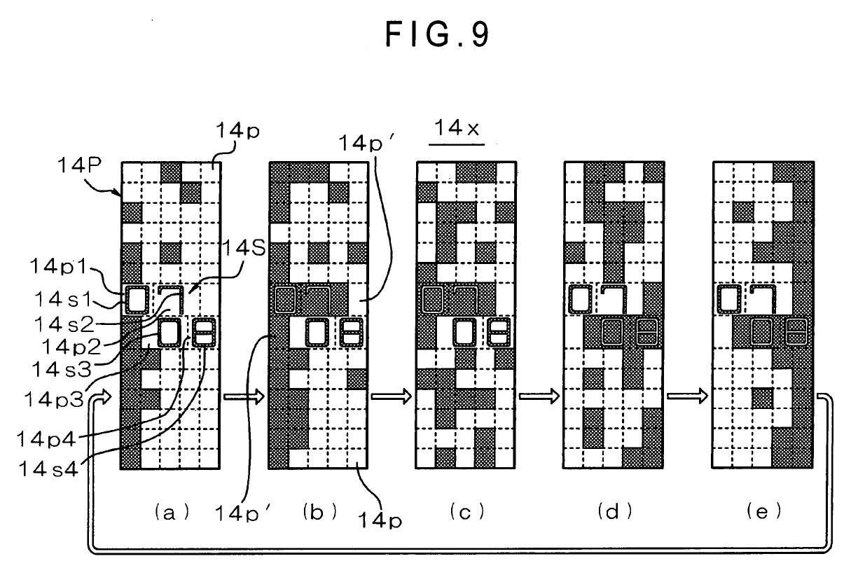

FIG. 9 is a plan view schematically showing a series of display patterns (a) to (e) displayed in the display area 14x of the display 14A of the exemplary embodiment. In this example, a great number of pixels 14p, 14p′, 14p1, 14p2, 14p3 and 14p4 are arranged vertically and horizontally (e.g., in a matrix form) in the display area 14x. Here, in the illustrated example, the display area 14x is substantially quadrangular (square or rectangular) and each pixel is also substantially quadrangular. While a plurality of pixels 14p having a common shape and size are arranged in the display area 14x, the pixels 14p′, 14p1 to 14p4 each having a size and a shape different from those of the pixels 14p are also arranged in the exemplary embodiment.

Segment groups 14s1 to 14s4 are respectively formed in the pixels 14p1 to 14p4. Each of the segment groups 14s1 to 14s4 contains a plurality of segment areas. In the illustrated example, each segment group has a 7-segment structure capable of displaying Arabian figures.

In the exemplary embodiment, the plurality of pixels 14p, 14p′ and 14p1 to 14p4 form a background display region 14P, while the segment groups 14s1 to 14s4 form an information display region (time information display region) 14S. One of the drive signals Dseg1 to DsegN is supplied to each of the pixels 14p, 14p′ and 14p1 to 14p4 and each of the plurality of segment areas in the segment groups 14s1 to 14s4. A display mode of each pixel is independently controllable in accordance with potential difference between the common signal Dcom and each of the drive signals.

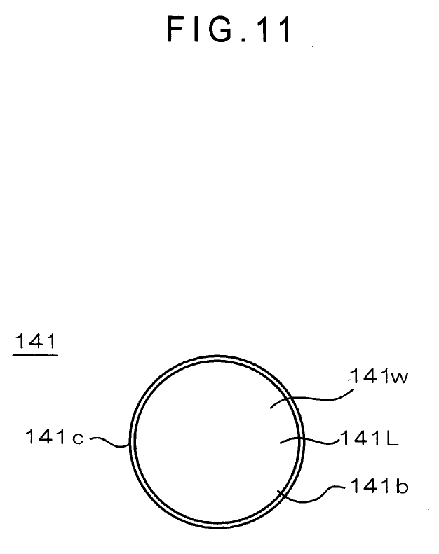

FIG. 11 is a sectional view schematically showing microcapsules 141, a great number of which are provided in the display 14A. The microcapsule 141 is a transparent sphere having a diameter of approximately 10 μm. The microcapsule 141 is filled with transparent fluid 141L and contains a lot of white particles 141w and black particles 141b suspended in the fluid 141L, the white and black particles 141w and 141b each being electrically charged. The white particles 141w and the black particles 141b are charged to have reverse polarities. In the exemplary embodiment, the white particles 141w are positively charged, while the black particles 141b are negatively charged.

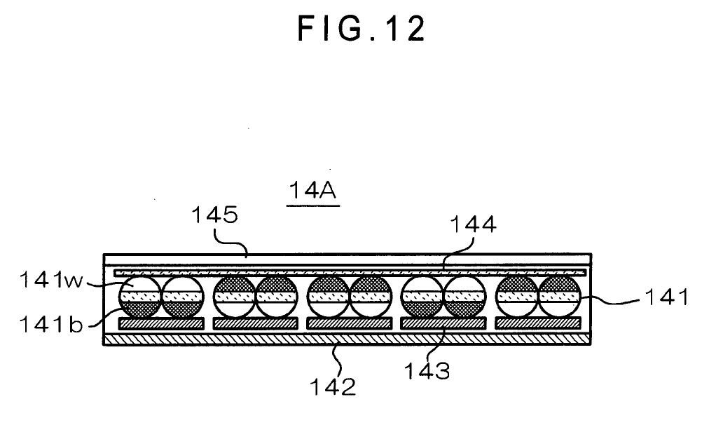

FIG. 12 is a vertical sectional view schematically showing an internal structure of the display 14A. The display 14A has a structure in which lower electrodes 143, the above-described microcapsules 141, an upper electrode 144 and an upper substrate 145 are layered in order of mention on a lower substrate 142. The upper electrode 144 is made of a transparent conductor such as ITO, while the upper substrate 145 is made of transparent materials such as transparent plastic and transparent glass.

In the illustrated example, the lower electrode 143 serves as a segment electrode, while the upper electrode 144 serves as a common electrode. A planarly-overlapped portion of the lower electrode 143 and the upper electrode 144 defines each of the pixels 14p, 14p′ and 14p1 to 14p4 and each of the segment areas of the segment groups 14s1 to 14s4. The drive signal is supplied to the lower electrode 143, while the common signal is supplied to the upper electrode 144. When the drive signal is controlled to apply the positive potential to the lower electrode 143 relative to the upper electrode 144, the negatively-charged black particles 141b in the microcapsule 141 move downward, while the positively-charged white particles 141w move upward. Accordingly, the inside of the microcapsule 141 becomes a state as shown in FIG. 11, so that the pixel formed by the plurality of aligned microcapsules is recognized as white when seen from the upper substrate 145 side. In contrast, when the drive signal is controlled to apply the negative potential to the lower electrode 143 relative to the upper electrode 144, the negatively-charged black particles 141b in the microcapsule 141 move upward, while the positively-charged white particles 141w move downward. Accordingly, the inside of the microcapsule 141 becomes a state reverse to the state shown in FIG. 11, so that the pixel formed by the plurality of aligned microcapsules is recognized as black.

It should be noted that although monochrome display in which each pixel can be displayed either in black or white is exemplified in the exemplary embodiment, the invention is not limited thereto. A color display may be employed using a color filter or the like. Although the display 14A is an EPD (Electrophoretic Display; microcapsule-type electrophoretic display module) using microcapsules each containing charged particles, the invention is not limited to such display. Various types of displays (preferably electrooptic displays) such as other types of EPD, an LCD (liquid crystal display), an ELD (electro luminescence display) may alternatively be used.

The display area 14x of the exemplary embodiment is so arranged that the background pattern displayed in the background display region 14P changes as time advances as shown in the series of display patterns (a) to (e) in FIG. 9. Specifically, as shown in the series of display patterns (a) to (e) in FIG. 9, sequential pattern shift at a predetermined time interval is repeated in the display area 14x. Meanwhile, an information pattern displayed in the information display region 14S changes in accordance with the change of the background patterns. The changes of the background pattern and information pattern are controlled by the display controller 14G described above.

In the exemplary embodiment, since the information pattern in the information display region 14S shows information essentially irrelevant to the background pattern (e.g., time information as shown in the illustrated example, where “0708” shows a date “July 8” or time “07:08”), a pattern shape of the information pattern changes independently (e.g., in accordance with time information). However, the hue or brightness of the information pattern changes in such a manner that the distinguishability (contrast) of the information pattern is secured in contrast to the background pattern in the display area 14x. In the illustrated example, when the pixels 14p1 to 14p4 including the segment groups 14s1 to 14s4 that form the information display region 14S are displayed in black, the information pattern in the information display region 14S (i.e., a lighting segment area out of the plurality of segment areas in the segment groups 14s1 to 14s4) is displayed in white. When the pixels 14p1 to 14p4 are displayed in white, the information pattern is displayed in black.

In short, in the exemplary embodiment, the display mode (the hue or brightness) of the information pattern in the display area 14x changes in contrast to the change of the background pattern so as to be distinguishable in the background pattern. For example, in a state shown in the pattern (a) of FIG. 9, lighting segment areas of the segment groups 14s1 and 14s2 showing “07” of the information pattern are displayed in black and the pixels 14p1 and 14p2 adjacent to the lighting segment areas are displayed in white. The pattern changes from this state to a state shown in the pattern (b) of FIG. 9, where the pixels 14p1 and 14p2 are black. If the information pattern “07” is unchanged and kept in black, the contrast of this information pattern becomes almost 0 (zero), which causes the information pattern to be indistinguishable. In the exemplary embodiment, by changing the display mode of the lighting segment areas of the segment groups 14s1 and 14s2 to white as shown in the pattern (b) of FIG. 9, the distinguishability (contrast) of the information pattern “07” is secured.

On the other hand, in a state where the information pattern “07” is displayed in white and the surrounding pixels 14p1 and 14p2 are displayed in black as shown in the pattern (c) of FIG. 9, when the background pattern changes to display the pixels 14p1 and the 14p2 in white as shown in the pattern (d) of FIG. 9, the information pattern “07” becomes indistinguishable if the information pattern “07” is kept in white. However, in the exemplary embodiment, by changing the information pattern “07” to be black as shown in the pattern (d) of FIG. 9, the information pattern becomes distinguishable.

The visibility (readability) of the information pattern “07” can be maintained as described above in the exemplary embodiment. Similarly to the information pattern “07”, the distinguishability of an information pattern “08” that is formed by lighting segment areas of the segment groups 14s3 and 14s4 can also be constantly maintained by changing the information pattern “08” so as to be contrast to the pixels 14p3 and 14p4, whereby the visibility of the information pattern “08” can be secured.

However, as for the information pattern “07”, when the display patterns change from the pattern (b) to the pattern (c), from the pattern (d) to the pattern (e) and from the pattern (e) to the pattern (a) in FIG. 9, the hue or the brightness of the pixels 14p1 and 14p2 adjacent to the segment groups 14s1 and 14s2 that form the information pattern “07” does not change. Accordingly, the hue or the brightness of the segment groups 14s1 and 14s2 that form the information pattern “07” remains unchanged, but the distinguishability of the information pattern can still be secured. Similarly, as for the information pattern “08”, when the display patterns change from the pattern (a) to the pattern (b), from the pattern (b) to the pattern (c) and the pattern (d) to the pattern (e) in FIG. 9, the hue or the brightness of the pixels 14p3 and 14p4 does not change. Accordingly, the hue or the brightness of the segment groups 14s3 and 14s4 remains unchanged, but the distinguishability of the information pattern can still be secured.

In the example shown in the patterns (a) to (e) of FIG. 9, although each of the pixels 14p, 14p′, and 14p1 to 14p4 changes at random between black and white in the background display region 14P, the entire display area 14x changes in such a manner that black pixel group gradually moves from the left side to the right side in the display area 14x, and this change is repeated. Meanwhile, the lighting segment areas of the segment groups 14s1 to 14s4 that form the information pattern are each controlled so as to be displayed in a color (brightness) inverted to the adjacent pixels 14p1 to 14p4 to maintain the contrast. Non-lighting segment areas of the segment groups 14s1 to 14s4 are preferably set so as to constantly keep sufficient contrast to the lighting segment areas, and particularly preferably set so as to have the same color and brightness as those of the pixels 14p1 to 14p4.

The display mode of the information pattern corresponding to the background pattern displayed in the background display region only uses two types of colors (i.e. black and white) in the example above. However, in monochrome display where a gradation control for three or more gradations is available, it may be so arranged that difference in brightness is generated between the information pattern and the adjacent pixels by the gradation control so that the information pattern becomes visible with sufficient contrast to the adjacent pixels. In color display, one of the hue and the brightness or both of them may be changed as the display mode. In such case, it may be so controlled that difference between the hue and/or the brightness of the information pattern and the hue and/or brightness of the adjacent pixels 14p1 to 14p4 is secured so that the information pattern becomes sufficiently visible.

Although the display mode of the information pattern is controlled in accordance with the display mode of the adjacent pixels 14p1 to 14p4 while the background pattern changes in the example above, the invention is not limited thereto. The background pattern may be controlled in accordance with the display mode of the information pattern to enhance the visibility of the information pattern. Even in such case, the display mode of the information pattern can be kept in contrast to the background pattern.

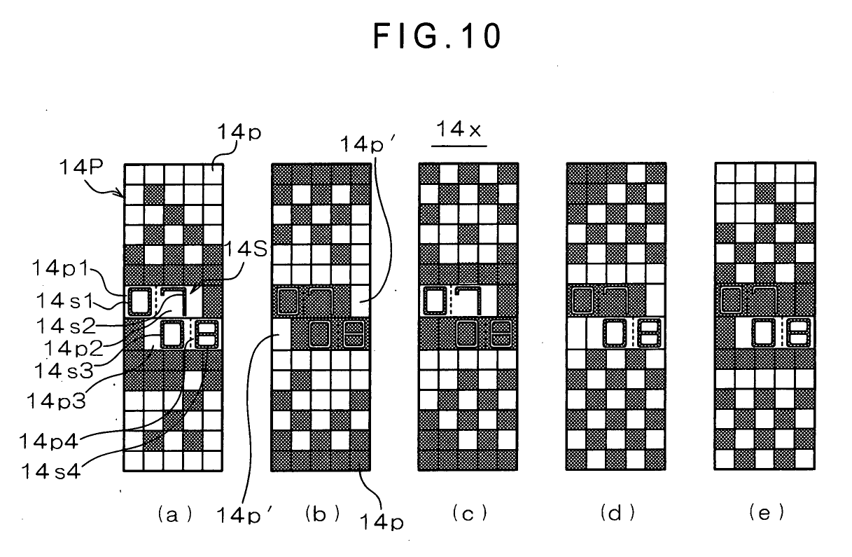

Specifically, in an example shown in FIG. 10, the display mode of the pixels 14p1 to 14p4 positioned between the background pattern formed by the plurality of pixels 14p, 14p′ and the lighting segment areas of the segment groups 14s1 to 14s4 that form the information pattern is arranged to be distinguishable from both of the display mode of the adjacent pixels 14p, 14p′ and the lighting segment areas.

For example, when the lighting segment areas of the segment groups 14s1 to 14s4 that form the information pattern are displayed in black as shown in the pattern (a) of FIG. 10, the pixels 14p1 to 14p4 surrounding the segment groups 14s1 to 14s4 are displayed in white and the plurality of the pixels 14p, 14p′ surrounding the pixels 14p1 to 14p4 are displayed in black. With the arrangement, a display position of the information pattern becomes clear and the information pattern can be displayed in a state similar to a whitely-edged state, thereby further enhancing the visibility of the information pattern. As shown in the pattern (b) of FIG. 10, when white and black are inverted from the state in the pattern (a) of FIG. 10, the visibility of the information can be enhanced as well.

The pattern (c) of FIG. 10 shows a state where the display mode as described above is applied only to the information pattern “07”. In such case, the lighting segment areas of the segment groups 14s1 and 14s2 that form the information pattern “07” are displayed in black, the pixels 14p1 and 14p2 surrounding the segment groups 14s1 and 14s2 are displayed in white, and the pixels 14p, 14p′, 14p3 and 14p4 surrounding the pixels 14p1 and 14p2 are displayed in black. The pattern (d) of FIG. 10 shows a state where white and black are inverted from the state shown in the pattern (c) of FIG. 10.

The pattern (e) of FIG. 10 shows a state where the display mode as described above is applied only to the information pattern “08”. In such case, the lighting segment areas of the segment groups 14s3 and 14s4 that form the information pattern “08” are displayed in black, the pixels 14p3 and 14p4 surrounding the segment groups 14s3 and 14s4 are displayed in white, and the pixels 14p, 14p′, 14p1 and 14p2 surrounding the pixels 14p3 and 14p4 are displayed in black. The information pattern “08” may be shown in a state in which white and black are inverted from the pattern (e) of FIG. 10.

In order to control the display mode of the information pattern as described above, a relation of the display data of the background display region 14P and the display data of the information display region 14S are incorporated in advance in the control data read from the memory 14M by the display controller 14G shown in FIG. 7. Specifically, a data component that indicates the display mode of the information pattern corresponding to the background pattern formed in the background display region 14P is reflected in the control data in advance, and the control data is read out and used to control the display driver 14D to drive the display area 14x as described above.

Alternatively the display controller 14G performs computation to obtain, from a display data portion corresponding to the background pattern formed in the background display region 14P, a data component of the display mode of the information pattern corresponding to the background pattern and generates the display data by reflecting the data component therein. In such case, the display mode of the information pattern can be controlled in contrast to any desired background pattern, which allows for instance, image data or the like input from the outside to be used as the background pattern.

A change mode of the background pattern may be arranged such that a plurality of pixels change collectively at a predetermined time interval as shown in the patterns (a) to (e) of FIG. 9 or each pixel changes individually. The time interval of the change may be arbitrarily set, where the time interval may be set long enough so that the background pattern is recognized to discontinuously change or may be set short so that the background pattern is recognized to continuously change. In addition, the time interval may be regularly set or irregularly set.

As an example in which the background pattern changes at a regular time interval, a change timing of the background pattern may be set in relation to the time information. For example, the background pattern changes every second, every minute, every hour or twice a day of morning and afternoon. The time interval for changing the background pattern is preferably set to a time unit smaller than a time unit in which the information pattern is changed (e.g., one day or one minute in the example shown in FIG. 9). With the arrangement, the change timing of the background pattern corresponds to the elapse of time, so that operating condition of a timer function of the display device 10 can be recognized. It may alternatively be arranged so that time can be recognized by the background pattern itself. For example, the background pattern may show a current position of the moon or the sun or may show a landscape corresponding to the outdoor brightness.

The invention is essentially fulfilled as long as the information pattern and a part of the background pattern adjacent to the information pattern are different from each other in terms of the display mode. However, it is preferable to set a certain level of standard for the difference of the display mode such that the difference becomes sufficiently large in order to enhance the visibility of the information pattern. For example, when difference in hue is employed, it may be so set in advance that combinations of hues that are highly distinguishable from each other (e.g., red and blue, yellow and purple, green and red) are used. When difference in brightness is employed, it may be so set in advance that the contrast ratio becomes equal to or higher than a predetermined value.

The information pattern changes in accordance with the change of the background pattern corresponding to this information pattern so as to be distinguishable from the background pattern in the above exemplary embodiment. However, the information pattern itself may repeatedly change between a plurality of display modes. Specifically, in the examples shown in FIGS. 9 and 10, the hue or the brightness of the lighting segment areas in the segment groups 14s1 to 14s4 that form the information pattern is changed in a cycle of 0.1 to 3 seconds. In other words, the information pattern is blinked in white and black. With the arrangement, at least one of the white and black is distinguishable from the background pattern no matter how the background pattern changes. In addition, by differentiating a changing cycle of the background pattern from a changing cycle of the information pattern, preferably in such a manner that the changing cycle of the information pattern becomes shorter, the distinguishability can be enhanced owing to the effect of the blinking, thereby securing the visibility of the information pattern.

In such case, the lighting segment areas in the segment groups 14s1 to 14s4 can be changed irrelevantly to the display mode of the surrounding background pattern, but the display mode of the lighting segment areas may be changed so as to be constantly distinguishable from the adjacent pixels 14p1 to 14p4, namely the pixels 14p1 to 14p4 may be blinked inversely with the blinking of the lighting segment areas.

The display device of the invention is not limited to that shown in the illustrated example, but may include various modifications without departing from the scope of the invention. For example, although the information pattern is expressed by figures in the illustrated examples, information may be provided by any desired pattern other than figures, e.g., by characters, graphics, or symbols.

Although the pixels 14p, 14p′ and 14p1 to 14p4 in the background display region 14P for forming the background pattern have relatively large areas in the illustrated examples, pixels may be formed by fine dots as a normal matrix display for displaying an arbitrary image as a background pattern.

In the exemplary embodiment described above, the hue, the brightness or both of them of the information pattern is changed. However, the change of the display mode of the information pattern may be performed through a change of the display position, the pattern shape or the pattern size of the information pattern, a change between a constant lighting state and an intermittent lighting state, a change between fixing and changing of the pattern shape or the pattern size and the like.

In the exemplary embodiment in which the display mode of the information pattern is changed in contrast to the change of the background pattern, the change of the background pattern and the change of the information pattern corresponding to the background pattern do not have to be completely synchronized. For example, the information pattern may be changed when a predetermined time period has passed from a time point at which the background pattern is changed. With this arrangement, although there is a slight time-lag until a change in contrast to the background pattern is generated in the information pattern, the distinguishability of the information pattern can be eventually secured. In contrast, the information pattern may be arranged to change before the background pattern changes. Also in such case, the distinguishability of the information pattern can be secured after the background pattern changes.

What is claimed is:

1. A display device, comprising: a pattern display unit having a display area in which a background display region for displaying a background pattern that changes as time advances and an information display region for displaying a predetermined information pattern are integrally provided, wherein
a display mode of the information pattern changes in accordance with a change of the background pattern in such a manner that the information pattern is distinguishable in the display area.

2. The display device according to claim 1, wherein the display mode of the information pattern changes in such a manner that the information pattern and a portion of the background pattern that is adjacent to the information pattern differ in at least one of hue and brightness.

3. The display device according to claim 1, wherein
a plurality of pixels are arranged vertically and horizontally in the background display region, and
the information display region is formed by one or more segment areas disposed in at least one pixel of the plurality of pixels.

4. The display device according to claim 3, wherein the one or more segment areas that form the information pattern change so as to be different from the at least one pixel at least in the hue and the brightness.

5. The display device according to claim 1, wherein the pattern display unit controls the display area based on display data in which a data component of the display mode of the information pattern corresponding to the background pattern is reflected in advance.

6. The display device according to claim 1, wherein the pattern display unit obtains a data component of the display mode of the information pattern from a display data portion of the background pattern and controls the display area based on display data in which the data component is reflected.

7. A display device, comprising: a pattern display unit having a display area in which a background display region for displaying a background pattern that changes as time advances and an information display region for displaying a predetermined information pattern are integrally provided, wherein
the information pattern repeatedly changes between a plurality of different display modes.

8. The display device according to claim 1, wherein the information pattern is a pattern showing time information.

9. The display device according to claim 7, wherein the information pattern is a pattern showing time information.
